(19) United States
(12) Patent Application Publication
(10) Pub. No.: US 2002/0146491 A1
(43) Pub. Date: Oct. 10, 2002

(54) Method and device for roof shingle-like displaying of sliced products

(76) Inventor: Stefan Stadtmuller, Sulzberg (DE)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/082,209

(22) Filed: Feb. 26, 2002

(30) Foreign Application Priority Data
Feb. 26, 2001 (DE) 101 09 142.7

(51) Int. Cl. A23L 1/00

(52) U.S. Cl. 426/232; 426/132; 312/134

(57) ABSTRACT

The invention relates to a method and a device for roof shingle-like displaying of sliced products, in particular of slices of food cut from bars of food. The slices are deposited on a display area. A measuring apparatus is provided, measuring at least one dimension of the product. The cut slice of the product is positioned on the display area on the basis of this information.

### BACKGROUND OF THE INVENTION

1. Field of the Invention

The invention relates to a method and a device for roof shingle-like displaying of sliced products, in particular of slices of food cut from bars of food, on a display area.

2. Description of the Art

The shingle-like arrangement of cut products is particularly popular in the food processing and presentation sector. Sliced meat and cheese are preferably presented in an overlapping arrangement so the food can be presented to the customer in a sales-promoting manner. The bars of food, which can be of considerable weight and length (for example between 100 kg and 150 kg and a length between 1.0 m and 2.0 m) are generally sliced by a high-performance machine cutting between 600 and 1,000 slices per minute from the bar of food. The cut slices are then deposited on a display area, wherein, for example, the display area is moved by a certain amount between each cut slice of the product, the overlap resulting in the finished shingle-like arrangement of the products. Arrangements are also known in which the display area is moved not only along one dimension but also in an area resulting, for example, in a circular or two-dimensional shingle-like arrangement.

The sales unit, for example packaging trays or packaging boxes, are often filled with a constant number of slices. This packaging unit determines the relevant length inside which the cut product is to be displayed in a shingle-like manner. An attempt is made to optimally fill the packaging unit using the predetermined parameters (relevant inner length of the packaging unit, number of slices per packaging, and height of the product) without the product protruding over the edge or there being a residual edge which does not look good.

If constant conditions always prevail the appropriate positioning can be determined in a simple manner. However, if, for example, products with changeable dimension, such as naturally shaped hams or circular cheeses etc., are to be sliced then there is the risk that the packaging unit will not be optimally filled.

### SUMMARY OF THE INVENTION

The object of the invention is therefore to improve a method and a device for shingle-like displaying of sliced products, as described at the outset, resulting in optimally filled sales or packaging units even in the event of changeable product dimensions.

To achieve this object the invention proceeds from a method, as described at the outset, and proposes that at least one dimension of the product is measured and the sliced product is initially positioned and afterwards displayed on the display area on the basis of this information. The proposal according to the invention provides that the product is measured in its dimensions, but that at least the height of the product is determined and the slice is positioned and displayed as a function of this information. The invention proposes that the slice is generally displayed on a display area. According to the invention it is irrelevant whether the slice is arranged in an overlapping manner on a display area designed as a conveyor and afterwards the overlapping arrangement conveyed to a sales unit or whether the product is placed directly in a sales unit serving as display area.

The invention is not limited to only ascertaining one dimension, namely the height of the product, in order to ultimately ascertain the corresponding position of the product in the sales unit. It is also possible to ascertain, for example, the cross-sectional area or also the thickness of the slice in order to obtain information herefrom for the display position of the slice.

According to the invention it is provided that the product or the height of the product or the cross-sectional area of the product is measured before or after the slice has been cut from the supply (for example the bar). Where the height of the product is of interest it is advantageous for this to be determined, for example, before cutting. This can be achieved, for example, by mechanical scanners etc. appropriately arranged in front of the cutting knife, the information being associated via the control unit with the corresponding slice so individual positioning of the slice is possible on the basis of the slice-typical information. However, it is alternatively also possible to obtain the dimension information after cutting the slice from the product. In particular, it is then simple to ascertain the thickness of the slice. However, it is also possible to determine the height or cross-sectional area of the product after cutting.

It is advantageous if the first cut slice or slice to be cut is measured at the start of a shingle-like arrangement and the information obtained hereby also serves for positioning of subsequent slices. Such a method of proceeding is particularly advantageous if a high degree of constancy of the relevant dimension of the product, for example the height or the cross-sectional area of the product, is to be expected along the product. It should be noted that the above-mentioned method and the device according to the invention yet to be described, are to be used in particular in high-performance machines and the dimension information obtained once can then be used for positioning subsequent, rapidly cut slices in the same manner without a relatively complex measurement and new calculation for each individual slice being carried out. The processing speed is not impaired by this variation of the invention and the invention can be used without problems in high-speed slicers. It is advantageous here that a measurement is always made at the start of a new shingle-like arrangement in order to take into account the new, possibly altered dimensions in the arrangement of the product. This means that sometimes idle passes have to be made anyway owing to the change of sales unit and this remaining time can simultaneously be used to obtain new product information and to use it as the basis for the new positioning of the subsequent shingle-like arrangement

However, as an alternative it is also possible that each cut slice or slice to be cut is individually measured and the slice is positioned on the display area on the basis of this information. Particularly with products, such as naturally shaped hams etc., which can have a markedly changing product dimension along their cutting direction, is it advantageous to measure each slice individually and to constantly re-determine herefrom the corresponding position of the product in the shingle-like arrangement. The arrangement of sliced foods consisting of a plurality of different types, for example, is also facilitated by this variation as each slice is optimally positioned in this case. A further optimisation step can also be provided here. Each slice to be displayed is initially measured and temporarily stored in a buffer station. Once all slices for a sales unit have been measured the control unit calculates from the existing data the respective display positions, the individual slices from the buffer station are then deposited on the display area in accordance with this information. In addition to the use of the invention with individual slices it is also possible to use the invention in the same manner with stacks consisting of a plurality of slices, these stacks then being arranged in a shingle-like manner.

Of course it is also possible to have mixed forms between the two above-mentioned variations, for example in that with a shingle-like arrangement of, for example, twenty slices, each fourth slice is remeasured and then a corresponding new positioning is provided.

In particular when a two-dimensional, for example a circular, shingle-like arrangement is to be achieved it is advantageous if the cross-sectional area of the slice is determined by measuring two directions of information oriented orthogonally to one another. In addition to the first variation in which only the height of the product ultimately determining the length of the shingle, is of interest, it can be advantageous with this variation to obtain from the slice two pieces of direction information oriented orthogonally or at right angles to one another and to obtain herefrom the corresponding position coordinates of this slice on the display area and thus subsequently in the packaging unit.

In a preferred configuration of the invention it is provided that the height of the product is measured for the slices overlapping substantially along one direction in a sales unit serving as display area and the respective position of the slice is determined as a function of the number of slices and the relevant length of the sales unit. It is ensured owing to a configuration of the invention of this type that the sales unit serving as display area, for example the packaging box or the packaging tray, is always uniformly filled even if the height of the slices is changeable. The inner dimension (with or without edge spacing) of the packaging box or packaging tray is to be regarded as the relevant length of the sales unit in this case, for example. The relevant length is provided in each case by the selected sales unit.

In a further improvement of the invention it is provided that the position of the product in the packaging unit is determined as a function of the measured dimension of the cut slice or slice to be cut, the relevant length of a packaging unit serving as display area, a limiting dimension for the overlap of the slices arranged in a shingle-like manner and the number of slices in the packaging unit. It is ensured owing to this variation according to the invention that a shingle-like arrangement of the product is achieved in each case in accordance with the limiting dimension for the overlap of the slice arranged in a shingle-like manner. In the event that slices which are too small are cut it is even possible with this variation that the control unit accordingly recognises this and proposes or independently selects a different packaging concept.

The invention relates not only to the method as described above but also relates in the same manner to a device for the shingle-like displaying of sliced products, the sliced product being located on a display area and conveyed toward a cutting knife cutting slices from the product and the cut slices being displayed on a display area. In the same way the object according to the invention is achieved in that a measuring apparatus is provided on the device, measuring at least one dimension of the product and passing this information to a control unit, and a positioning unit controls the display position of the slice on the display area as a function of the values input by the control unit.

The measuring apparatus ascertains information here relating to a dimension, for example the height of the product or a different dimension, of the product to be cut. The control unit which may be designed, for example as a programming part of the machine control, has an appropriate processing instruction for this dimension information and then provides the positioning unit with a corresponding control value as to where the slice cut is to be deposited on the display area using the appropriate dimension information. In the process the available sales unit, namely the packaging box or the packaging tray, is optimally used owing to the appropriate configuration of the instruction in the control unit. However, the use of the measuring apparatuses is not restricted in the scope of the invention only to determining the cross-sectional area or information regarding the height of the product etc., but can also be used in the same way to measure the thickness of the product slice and other dimensions of the product. With a configuration of this type the variability of a corresponding device is increased as it is possible to optimally fill relatively complex packaging shapes and to do this in a cost-effective, automatically attractive and sales-promoting manner.

It is provided that the measuring apparatus mechanically scans or optically ascertains the height, the cross-sectional area or another dimension of the product. Laser measuring of the relevant information areas or dimensions is also possible in addition to the use of mechanical scanners. It is also possible, within the scope of an optical measuring apparatus, to read out the cross-sectional area, for example using a line scanning camera and to derive the height of the product or other dimension information from the information obtained hereby.

It is advantageous if a display conveyor or a packaging unit, for example a sales unit, for example a packaging box or a packaging tray, is provided as display area. The use of the invention is not restricted to where the cut slices are initially deposited. In the same way it is possible to use the invention in devices where the product is temporarily stored on a display conveyor or is buffered and is only then passed into an appropriate sales unit, or in which the slices are placed directly in an appropriate sales unit.

The control unit predetermines the positioning unit coordinates in accordance with which the positioning unit controls the arrangement of the slice on the display area. It is provided here that the positioning unit controls the position of the display area or the display position on the display area. Ultimately it comes down to a relative positioning. The display area itself is advantageously controllable, for example if it is designed as a conveyor the display position on the display area can be changed by a simple advance of the conveyor in such a way that the desired shingle-like arrangement is achieved. However, in addition it is also possible to design the display area as a table movably mounted along two dimensions, in other words in a plane, and therefore also allowing a shingle-like arrangement. The positioning unit is not limited to a one- or two-dimensional arrangement here. It is also possible for the positioning unit to control the position of the slice to be deposited on the display area in terms of height, in other words in a third dimension. According to the invention it is provided that the positioning unit preferably acts on the display area, wherein this does not restrict the invention hereto. It is also possible for the positioning unit to act on the location of the cutting of the slice from the product and executes the appropriate control there. In the same way it is also possible for the positioning unit to act on the cutting knife or an interconnected intermediate belt. Ultimately, appropriate positioning of the slice in the shingle-like arrangement depends on the relative position of the display area on the one hand and cut slices on the other hand.

### BRIEF DESCRIPTION OF THE DRAWINGS

The invention is shown schematically in the drawings, in which:

FIG. 1 to 3 show in a plan view schematic arrangements of the cut product in accordance with the invention.

### DETAILED DESCRIPTION

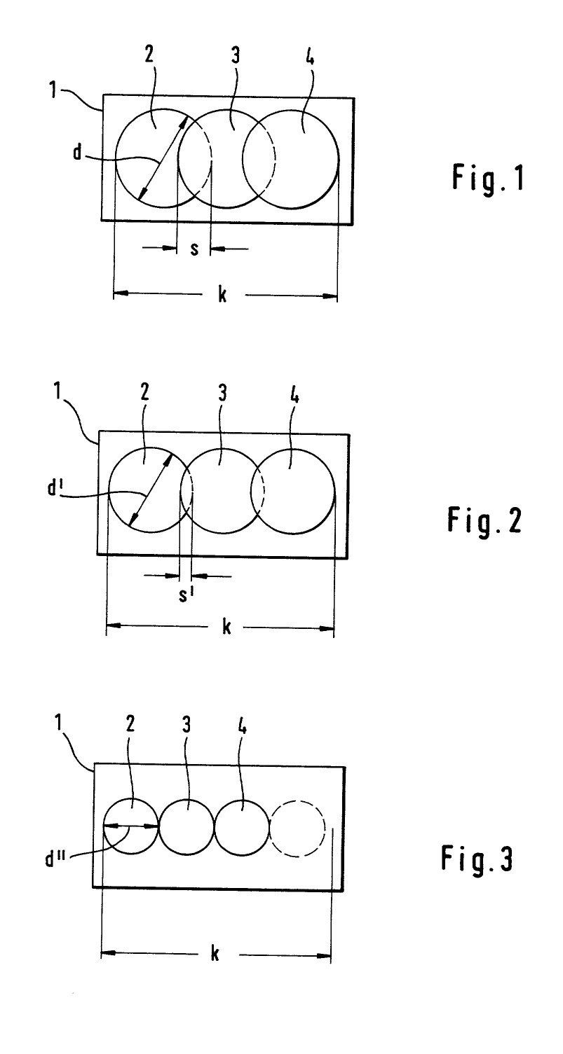

The slices 2, 3, 4 are arranged in a sales unit 1 in various examples in FIG. 1 to 3.

In the first configuration of FIG. 1 the relevant length k of the sales unit is optimally filled by the three slices 2, 3, 4. On the basis of the length k of the sales unit 1 and of the height d of the product ascertained by the measuring apparatus (not shown here) and the number n of slices (here three slices) the following equation A of the overlap s is produced:

$$s = \frac{n * d - k}{n - 1} \qquad ( A )$$

Positioning xᵢ of the respective slice i results in the arrangements overlapping in one dimension here, for example in accordance with the following formula D:

xᵢ=(i−1)*(d−s)where i is from 1 . . . n (D)

The values xᵢ are the values ascertained in accordance with the above-mentioned equations A and D by the control unit and are transmitted to the positioning unit so the 2, 3, 4 optimally fill the inner dimension k of the sales unit 1.

In comparison, FIG. 2 shows that the 2, 3, 4 are placed in the same sales unit and are to use the relevant length k in the same way. As the height d′ of the product is smaller here than the height d of the product in FIG. 1 there is also a smaller overlap s′. Despite this the overlap is calculated in the same way owing to the prescribed correlation in accordance with equation A and the respective positioning xᵢ calculated.

In FIG. 3 even smaller slices 2, 3, 4 are to be placed in the packaging box 1 resulting in the fact that with the given number of slices and the available height d″ of the product, an overlap s is no longer possible, as shown.

It is then provided in the control unit of the device according to the invention that an alternative packaging form is optionally offered. In this case provided as criterion is, for example, the fact that the overlap s is below a limit value derived, for example, from the relevant inner length k of the packaging or sales unit 1:

s<k*j (B)

wherein j=the fraction of overlap of two adjacent slices, generally designating a value between 0 and 1.

A limit value for the product height dₘᵢₙ is produced in conjunction with equation A by equation C.

$${d}_{min} < \frac{k}{n} * [ j ( n - 1 ) + 1 ] \qquad ( C )$$

With a configuration of this type it is therefore possible to establish a height dₘᵢₙ of the product even with a predetermined number n of slices, below which, for example, an increase in the number n of slices is then proposed or a different sales unit 1 is selected from the supply and filled.

As can also be seen in FIG. 3 it can also be advantageous for, for example, two rows instead of one row of cut food slices to be arranged next to one another in the packaging unit in order to optimally use the packaging area.

The claims submitted with the application now and to be submitted later on constitute attempts at wording without prejudice to the obtaining of continuing protection.

The relationships cited in the dependent claims refer to the further development of the subject of the main claim provided for by the features of the respective sub-claims. However, these relationships must not be interpreted as waiving the requirement to obtain independent, subjective protection for the features of the related sub-claims.

Features which so far have only been disclosed in the description may be claimed in the course of the proceedings as being of significance to the invention, for example for delimitation from the prior art.

1. A method of displaying sliced products, in particular slices of food cut from bars of food, on a display area, the method comprising:
measuring a dimension associated with at least one of a number of slices of the product to be displayed on said display area; and
positioning said slices of the product on the display area on the basis of said dimensional information.

2. A method according to claim 1, wherein said dimension associated with said at least one slice is measured before said at least one slice is cut.

3. A method according to claim 1, wherein said dimension associated with said at least one slice is measured after said at least one slice is cut.

4. A method according to claim 1, wherein a dimension associated with a first slice of the product to be positioned on said display area is measured, and the dimensional information obtained is used to position all subsequent slices of the product on said display area.

5. A method according to claim 1, wherein a dimension associated with each slice of product to be positioned on said display area is measured individually, and each said slice of product is positioned on said display area on the basis of its respective dimensional information.

6. A method according to claim 1, wherein the cross-sectional area of said at lest one slice is determined by measuring two dimensions oriented orthogonally to one another.

7. A method according to claim 1, wherein for an arrangement in which a plurality of slices are to be displayed along one direction on said display area, the height of said at least one slice is measured and the respective positions of said slices are determined as a function of the number of slices and the relevant length of said display area.

8. A method according to claim 1, wherein the position of a slice of the product on the display area is determined as a function of the measured dimension, the relevant length of the display area, a limiting dimension for the overlap of the slices of the product, and the number of slices to be displayed on the display area.

9. A device for displaying of sliced products, in particular for carrying out a method according to claim 1, comprising:
a measuring apparatus for measuring at least one dimension (d) associated with at least one of a number of slices of the product (2, 3, 4) to be displayed on a display area;
a control unit for processing information from the measuring apparatus; and
a positioning unit for controlling the display position of said slices (2, 3, 4) on said display area in response to values input by the control unit.

10. A device according to claim 9, wherein the measuring apparatus mechanically scans the product to measure said dimension

11. A device according to claim 9, in which the measuring apparatus uses optical means to measure the dimension.

12. A device according to claim 9, wherein a display conveyor is provided as said display area.

13. A device according to claim 9, wherein a sales unit, for example a packaging box or tray, is provided as said display area.

14. A device according to claim 9, wherein the positioning unit controls the position of said display area

15. A device according to claim 9, wherein the positioning unit controls the display position on said display area.
